(19) United States
(12) Patent Application Publication
(10) Pub. No.: US 2013/0180172 A1
(43) Pub. Date: Jul. 18, 2013

(54) Rotating Plant Containing Module With Self-Contained Irrigation System

(71) Applicant: H. Gene Silverberg, Glencoe, IL (US)

(72) Inventor: H. Gene Silverberg, Glencoe, IL (US)

(21) Appl. No.: 13/352,159

(22) Filed: Jan. 17, 2012

(51) Int. Cl. A01G 27/02; A01G 9/02

(52) U.S. Cl. 47/65

(57) ABSTRACT

A multi-sided, rotating plant holder, including a hollow shell structure. Orifices are positioned along at least one side of that shell structure for accessing and replacing plants within that shell structure. The plants positioned in the hollow shell structure may include plugs for ease of placement and replacement in and out of the orifices. A growth medium contained within that shell structure secures the plants within the plant holder, and holds water and nutrients for absorption by the plants. The plant holder includes an upper base element that is rotatable upon a lower base element to allow for rotation to sunlight or artificial light.

### TECHNICAL FIELD

The invention relates to a compact, vertical plant-containing module, especially suitable for use on a table top or a desk top.

### BACKGROUND

Plants are common additions to interior spaces, such as homes and offices. Typically, these plants grow upwardly from a container that is filled with soil, compost or other hydroponic growth media. The plants are watered and exposed to natural or artificial light on a periodic basis. The water is brought to the pots directly by pipe, hose, or containers filled with water.

Like all plants, conventional house plants require real or artificial light on a regular basis. Some house plants require more light than others, and must be positioned to face the sun or the artificial light source. This can be accomplished by rotating or moving the plants to provide their different sides with access to the sun or the artificial light source.

Plant installations may also be mounted on vertical surfaces, i.e., perpendicular to the ground. Particularly, the plants are mounted to vertical, self-supporting structures, or to vertical walls. When secured in this manner, these plants are generally fixed to the structures or walls. This fixed orientation limits the exposure of the plants to natural or artificial sunlight. Because of this limited exposure, plant species secured to stationary vertical surfaces are chosen on the basis of their ability to thrive in these less than ideal light conditions. Even in the absence of sunlight, plants secured to either horizontal or vertical surfaces may readily grow in any direction, if electrically-powered artificial light is used.

### SUMMARY

One embodiment described herein is a multi-sided, rotating plant holder, small enough for use on a table top, with an internal water reservoir and hand pump able to irrigate its plants for up to thirty (30) days. Water and nutrients may be resupplied to the plant holder, by manually placing them into internal water and nutrient tanks or reservoirs.

The plant holder may be of any shape, including rectangular, spherical, or hemispherical. The plant holder is supported by an underlying shell structure.

Orifices are placed on the exterior of the plant holder. These orifices permit access to a growth medium in the interior of the plant holder. These orifices also permit the removal of old plants, and insertion of new plants, in a manner to be more thoroughly described in this specification.

These orifices are positioned along at least one side of the plant holder. In one embodiment, these orifices are formed in panels that are secured to one side of the shell structure. The panels also aid in securing the growth medium within the shell structure, and reducing the evaporation of water from the growth medium.

Optionally, when orifices are positioned along one side of the plant holder, the opposite side of the holder may include non-botanic media, such as corporate logos, paintings, plain or decorated paper sheeting, or discrete inserts, such as small-sized images of persons. Of course, if this opposite side of the holder includes non-botanic media, no growth medium need be secured to the side of the plant holder 10 that includes such non-botanic media.

Preferably, the growth medium is shaped into a brick-like or module form. A plurality of such modules or bricks is placed within the shell structure. Each brick may be stacked above or below, and placed next to, another brick or module.

Each of the modules is secured within the shell structure. Typically, the growth medium-containing modules are obtained from a supplier, and are pre-moistened. Thus, the modules may be installed directly into the shell structure. Water is retained within the growth medium, to facilitate the hydration of the plants.

A thin, horizontally disposed sheet is positioned adjacent the bottom of each of the modules. This thin sheet diverts excess water from the modules to channels that are formed in a thin, flat drainage mat. Those channels, which are typically formed and positioned diagonally within that drainage mat, then divert that water to a run-off or overflow tank.

The plant holder further includes a main water supply tank. A pump, most preferably a manually-actuated, spring-biased pump, is provided for moving water from the water supply tank into a position above the growth medium, enabling sprinkling of the water onto the growth medium.

The plant holder may also include an upper base element and a lower base element. These elements are generally concentric, and relatively rotatable, such that the upper base element rotates upon the lower base element. The upper base element is similar in configuration to a concave dish, enabling it to collect and contain excess, overflow water that drains from the growth medium.

In yet another embodiment, the plurality of orifices along the side of the shell structure are formed in a side panel. Preferably, once assembled with the shell structure, that side panel is permanently secured to the shell structure.

The thin, flat drainage mat described above is positioned within the shell structure, and extends vertically along a portion of that structure. As noted above, channels are formed upon the thin, flat drainage mat. The channels, preferably of a diagonal orientation, collect excess water draining from the growth medium, and divert that water to a run-off or overflow tank.

The plant holder may also include a plant that is secured to a substantially cylindrical plug. The plug may be made of any suitable growth medium. An individual plant, or a cluster of plants, is retained within that plug. The plants may be leafy green plants, flowering plants, fruits or vegetables, herbs, or any other suitable plants.

The plant and its cylindrical plug are retained within defined recesses, formed in the growth medium of the modules or bricks. These recesses are approximately the same diameter as the cylindrical plugs, so that the plugs and their plants may be secured within the recesses in the modules. When a plant within the plant holder dies, or when it is otherwise desirable to replace that plant, the cylindrical plug holding that plant is removed from the recess within the module. A new cylindrical plug, with new plants, is inserted in its place within the defined recess.

### BRIEF DESCRIPTION OF THE DRAWINGS

FIG. 1 is a perspective view of two opposite sides of a preferred embodiment of the plant holder as described herein;

FIG. 2 is a front view of the plant holder of FIG. 1;

FIG. 3 is a top view of the plant holder of FIG. 1, and showing its underlying oval shaped base;

FIG. 4 is a side view of the plant holder of FIG. 1;

FIG. 5 is a perspective view of two snap-fit pieces that together comprise the outer, hollow shell structure of the plant holder as described herein;

FIG. 6 is a front elevation of an exemplary plant holder as described herein;

FIG. 7 is a side sectional view of the plant holder of FIG. 4;

FIG. 8 is a view of the plant holder of FIG. 4, but with the hollow shell structures of FIG. 5 removed;

FIG. 9 is a view of the plant holder of FIG. 2, but with the hollow shell structures of FIG. 5 removed;

FIG. 10 is an exploded, perspective view of inner portions of the plant holder of FIG. 1, including those portions that hold the growth medium that facilitate the watering of the growth medium and enable the collection of drain water from the growth medium;

FIG. 11 is a perspective view of the water reservoir portion of the plant holder of FIG. 1, with an upwardly extending tube for containing a manually-actuated pump;

FIG. 12 is a perspective view of a side panel for the plant holder as described herein;

FIG. 13 is a cutaway perspective view of a portion of the manually activated pump;

FIG. 14 is an exploded, perspective view of an exemplary plant holder as described herein;

FIG. 15 is a perspective view of the plant holder of FIG. 1 with plants;

FIG. 16 is front view of an exemplary plant holder showing plants inserted into the orifices;

FIG. 17 is a perspective view of an exemplary plant package containing plants;

FIG. 18 is a perspective view of an exemplary plant holder having a first design secured to a side of the plant holder;

FIG. 19 is a perspective view of an exemplary plant holder having a first design secured to a side of the plant holder;

FIG. 20 is a side elevation of FIG. 18 or 19;

FIG. 21 is a front elevation of FIG. 19 also showing plants;

FIG. 22 is a front elevation of FIG. 18 also showing plants.

### DETAILED DESCRIPTION

This portion of the specification describes a preferred embodiment of the invention. It is to be understood that the below description is but one example of the invention. Many other examples of the invention are contemplated. As a result, it is to be understood that the scope of the invention is limited only by structures that come within the scope of the granted claims, and by structures deemed to be equivalents of those described in the claims.

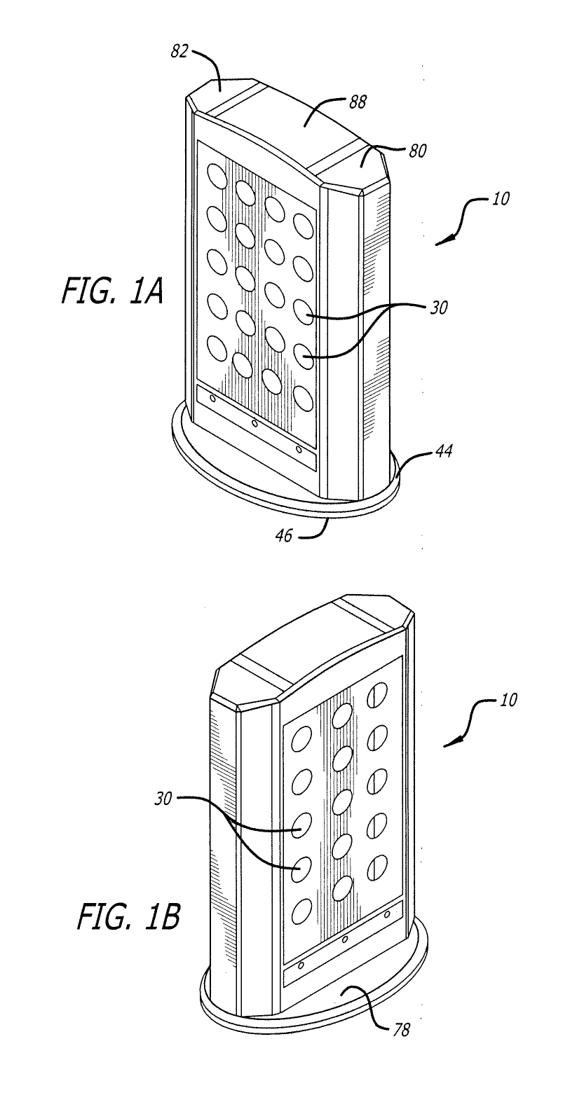

Referring now to FIGS. 1-4, the preferred embodiment comprises a multi-sided, rotating plant holder 10. A typical plant holder 10 in accordance with the invention may be eight (8″) to fifteen (15″) inches in height, and approximately nine (9″) inches in length. Given its compact dimensions, the plant holder 10 is highly suitable for indoor use, and most suitable for use and display on either a table top or a desk top. However, given its compact and portable nature, it should also be understood that the plant holder 10 may also be used in outdoor environments.

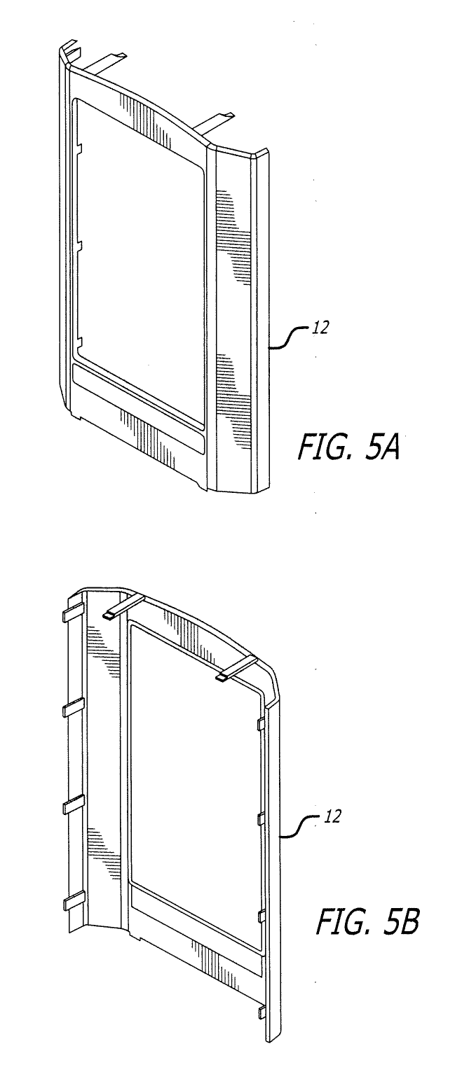

As may best be seen in FIG. 5, the plant holder 10 is preferably formed of a two-piece, hollow shell structure 12. This shell structure 12 can be made of any suitable material, including a hard plastic, a biodegradable plastic, or a relatively corrosion-free metal, such as aluminum. As will be explained in more detail later, the two pieces of the shell structure 12 snap together, so as to retain and slightly compress the inner components of the plant holder 10.

While the shell structure can have any number of sides, the hollow shell structure 12 of this preferred embodiment includes eight sides. As may be seen in FIGS. 3 and 4, the first side 14 and second side 16 are typically parallel to each other, and are relatively large. In this embodiment, the first side 14 and second side 16 provide the primary surfaces for the support of plants (or other media) on the exterior of the plant holder 10.

In contrast, as may be seen in FIGS. 3 and 4, the third 18, fourth 20, fifth 22, sixth 24, seventh 26, and eighth 28 sides of this embodiment are relatively smaller and narrower. In the present embodiment, the third 18, fourth 20, fifth 22, sixth 24, seventh 26, and eighth 28 sides do not provide support surfaces for plants. However, it is understood that these sides 18, 20, 22, 24, 26, and 28 may optionally provide plant support surfaces.

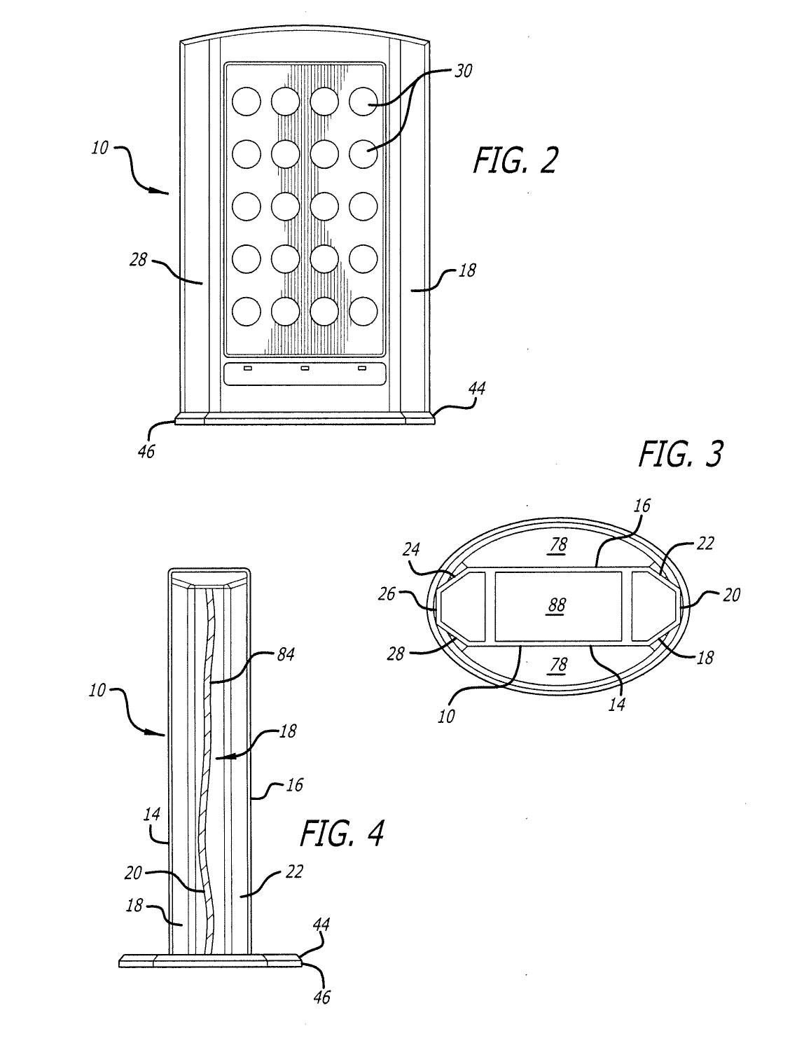

As may best be seen in FIGS. 1 and 2, orifices 30 are positioned along at least one side of the shell structure 12. In this embodiment, these orifices 30 appear in both the first side 14 and second side 16. As will be more fully explained below, these orifices 30 provide the user with access to the interior of the hollow shell structure 12. This access enables the removal of older plants from, and the insertion of new, substitute plants into, that shell structure 12.

The orifices 30 may be of any suitable size. While in the embodiment of FIG. 1, the twenty orifices on each of the first side 14 and second side 16 are relatively large, the orifices 30 can be made significantly smaller. No particular number of orifices 30 is most desirable. In fact, both the size and the number of orifices 30 is entirely up to the user. An infinite number of orifices 30 is theoretically possible.

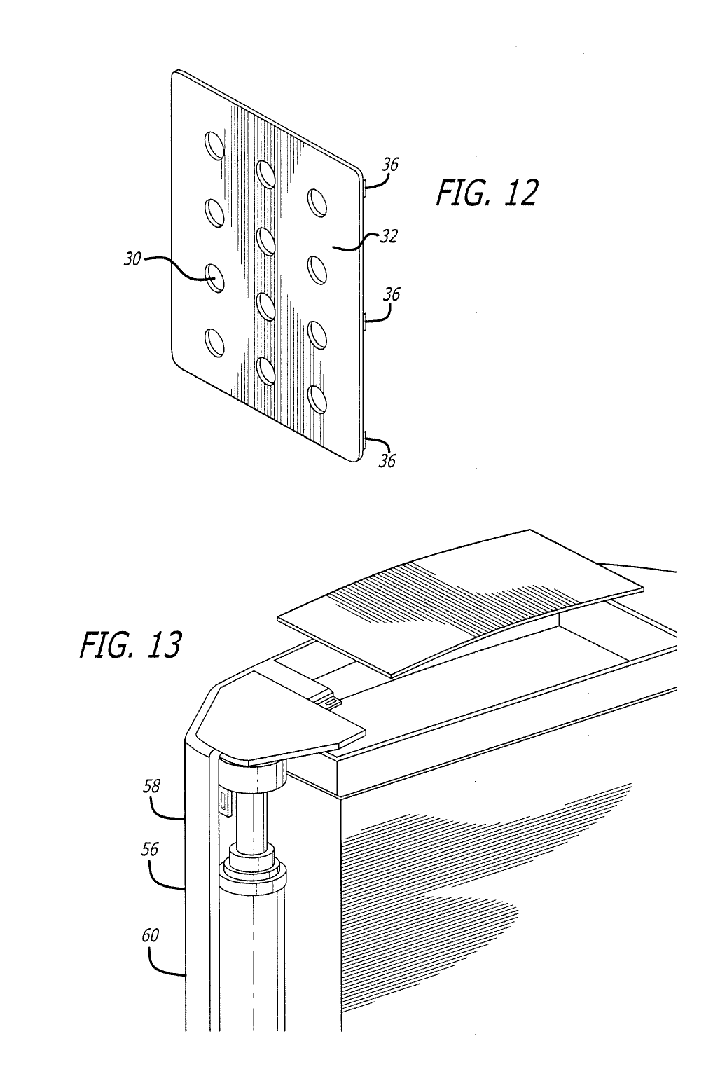

In the present embodiment, as may best be seen in FIG. 12, the orifices 30 are formed in side panels. Particularly, identical side panels 32 and 34 (not shown) are placed into the shell structure 12 along the first side 14 and the second side 16, respectively.

The side panels 32 and 34 (not shown) include one or more tabs 36. The tabs 36 enable the side panels 32 and 34 to be secured in the rotating plant holder 10. Permanent securement is desirable; this ensures that the contents of the hollow shell structure 12 are retained within the plant holder 10. The permanent securement of the panels 32 and 34 onto the shell structure 12 of the plant holder 10 also reduces the amount of water that evaporates from the growth medium, and keeps that growth medium moist, as will be described below.

It will, however, be understood that the side panels 32 and 34 could also be removably secured to the rotating plant holder 10. Such removable securement of the panels would enable the user to replace both panels 32 and 34, and thereby replace the plants in those panels 32 and 34 with new plants that are “pre-loaded” into new replacement panels. Such pre-loaded panels would be available in the aftermarket, through retailers such as hardware stores or web-based merchants. The replacement of entire panels contrasts with the mere replacement of certain individual, pre-designated plants secured within the plant holder 10.

As noted above, new “pre-loaded” replacement panels require that the older panels are removable from the rotating plant holder 10. Removal occurs when the plants in the plant holder 10 are no longer fresh, or when the user wishes to simultaneously replace all of the old plants, for any other reason. In this case, the side panels 32 and 34 containing the old plants may be removed from the hollow shell structure 12, and are replaced with entirely new side panels, having entirely fresh plants.

Referring now to FIG. 7, the plant holder 10 may also include a plurality of stacked, adjacent (i.e., side-by-side) modules 40. These modules 40 are shaped substantially like bricks. Any suitable number of such modules 40 or bricks may be placed within the plant holder 10.

FIG. 7 shows portions of vertically stacked and separate modules 40 on the left and rights sides of the plant holder 10. It should be understood, however, that these separate modules 40 could also be secured to one another, to create a unitary module.

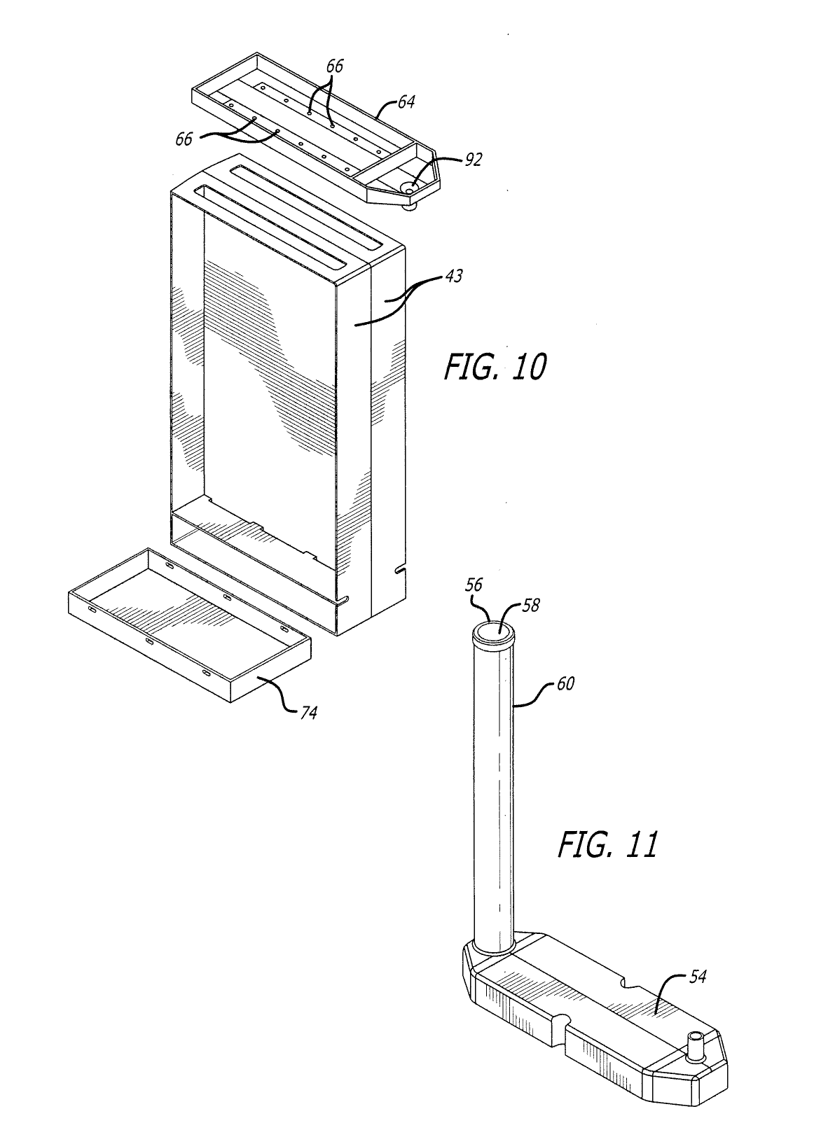

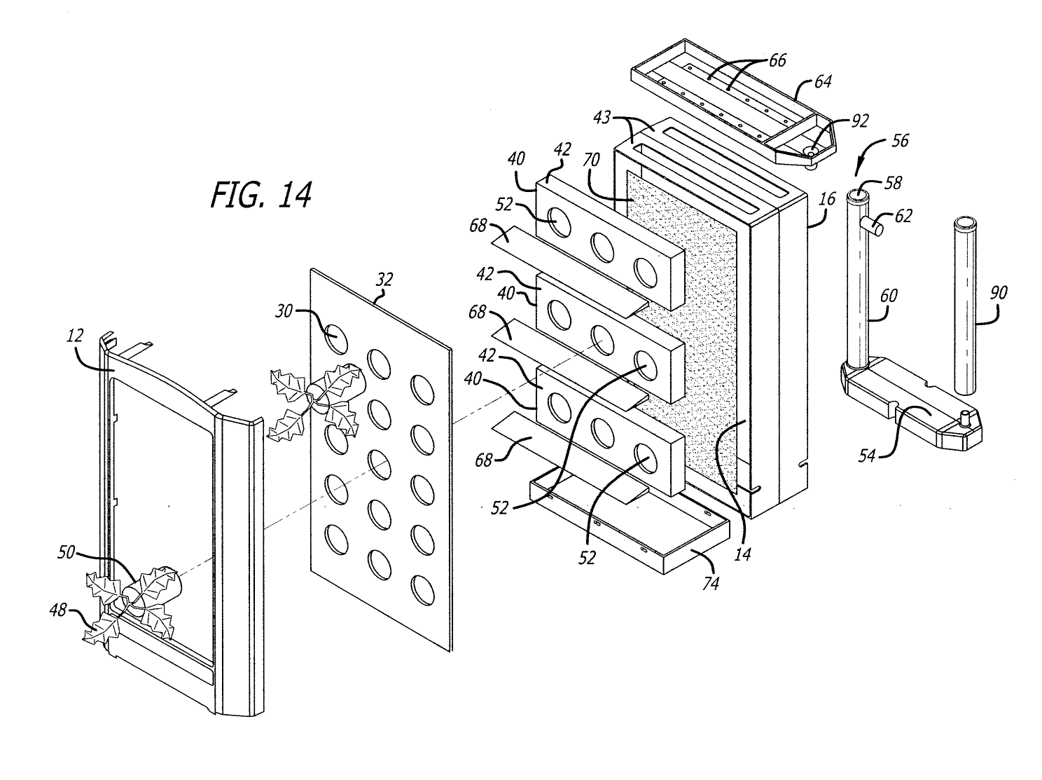

These modules 40 are made of a growth medium 42. Preferred and suitable growth media 42 include natural soil. However, the most preferred growth medium 42 is an inert substance that does not decompose, such as the mineral fiber-based material, Gro/Dan™ Gro/Dan™ is a dense horticultural form of Rockwool, and has been used for growing plants for over thirty years. These modules 40 may be placed in a frame 43 which may be dimensioned to hold any suitable number of modules 40. As shown in FIGS. 10 and 14, two frames 43 are placed back-to-back for holding modules on either side 14, 16 of the plant holder 10.

The inert growth medium is capable of absorbing and storing water and nutrients fed to the plants through a pump-type watering system, to be described below, such that water (and optionally nutrients) are delivered and distributed to the roots of the plants. The inert growth medium 42 also reduces the amount of water needed for growing and maintaining plants, by its ability to absorb and hold large amounts of water over extended periods of time.

As may be seen in FIGS. 1, 2, and 4, the rotating plant holder further includes an upper base element 44 and a lower base element 46. In this embodiment, the upper base element 44 is fixed relative to the plant holder 10. Ball bearings between the lower base element 46 and the upper base element 44 facilitate the relative rotation of the lower base element 46 and upper base element 44. In this way, the entire plant holder 10 may be rotated to provide optimum exposure of its plants to natural and artificial light.

The upper base element 44 includes concave upper surface 78. This concave upper surface 78 serves to receive overflow water from the modules 40 or bricks.

As may be seen, the preferred rotating plant holder 10 is of a generally trapezoidal, eight-sided shape. However, the rotating plant holder may also be of a generally spherical or hemi-spherical or triangular shape, or any other suitable shape.

As discussed briefly above, the rotating plant holder 10 includes side panels 32 and 34. The orifices 30 within those side panels 32 and 34 are used to provide access to the interior regions defined by hollow shell structure 12 of the plant holder 10, and to provide access to the modules 40.

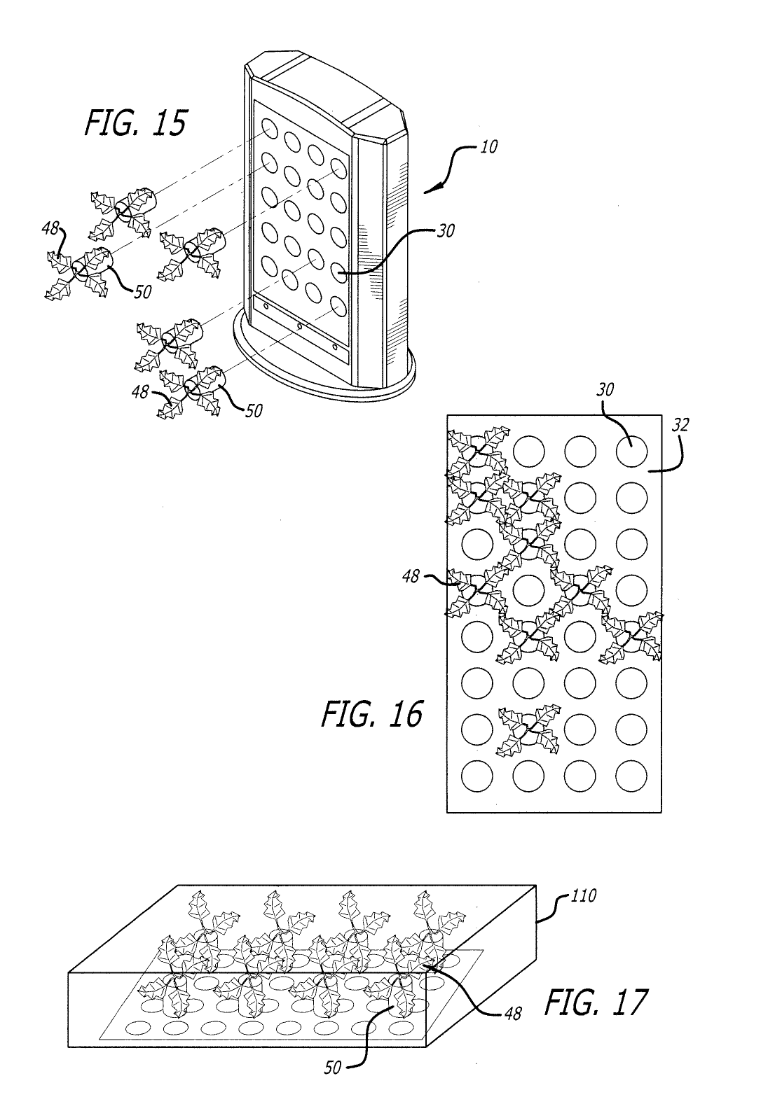

Particularly, as may be seen in FIGS. 7 and 14-16, the plant holder 10 may include a plant 48 that is secured to a substantially cylindrical (or cork-shaped) plug 50. The substantially cylindrical plug 50 is comprised of soil or a hydroponic growth medium. The plug 50 may be comprised of the same type of growth medium as is contained within the modules 40, or of a different type of growth medium. As may best be seen in FIGS. 7 and 16, that plug 50 is insertable through the orifices 30 of the removable side panels 32 and 34, to secure the plant 48 into the modules or bricks 40.

As may be seen in FIG. 7, the plant holder 10 may include recesses 52 formed within each of the side-by-side modules 40. These recesses 52 and the plugs 50 are shaped and sized in a complementary manner. In this example, the recesses 52 are approximately the same diameter as the diameter of the substantially cylindrical plugs 50. In this way, the plugs 50 and their plants 48 may be tightly secured within the recesses 52 of the modules 40.

In the event that the plant 48 in the rotating plant holder 10 has shriveled, or if it is otherwise desirable to replace it, the plant 48 may be pulled outwardly and away from the module 40 in which it is inserted and contained. Such a pulling force causes the plug 50 to pop out of its corresponding recess 52 within its module 40. A new plant-containing plug 50, with a new plant 48, may thereafter be pushed into the recess 52, again through the orifices 30 within the side panels 32 or 34. From this, it is clear that the orifices 30 on the outside of the rotating plant holder 10 permit the user to access the growth medium 42, and insert the new plants 48.

As may be seen in FIGS. 7, 8, 9, 11 and 14, the rotating plant holder 10 includes an internal water reservoir 54. In this preferred embodiment, the internal water reservoir 54 has a capacity of approximately eight (8) ounces. As may be seen in FIGS. 9, 11, 13 and 14, the plant holder 10 further includes a manually activated, spring-loaded pump 56. This pump 56 includes a handle 58 for manual actuation of that pump.

As may be seen in FIGS. 11, 13 and 14, when a user presses on the handle 58 of the manually activated pump 56, water from the internal water reservoir 54 is drawn upwardly into a supply tube 60. The water in the supply tube 60 is drawn by the action of the pump 56 to a point above the topmost modules 40. As seen in FIG. 14, the pump 56 may include a discharge spout 62 for spraying or otherwise dispensing water drawn by pump 56 through supply tube 60.

As may be seen in FIGS. 10 and 14, the plant holder 10 includes a water distributing tray 64 with a plurality of distributing holes 66. Water being discharged from the discharge spout 62 of the manually activated pump 56 falls into the water distributing tray 64, and then drips through the distributing holes 66, for sprinkling onto the modules 40. The holes 66 are sized to permit approximately six ounces of water to drip through those holes 66 in approximately one to two minutes. Such slow dripping of the water onto the modules 40 ensures that the plant growth medium absorbs all of that water.

The discharge spout 62 of the pump 56 is positioned above the top-most module 40. These top-most modules 40 typically dry prior to the lower modules 40, and will need watering prior to those lower modules 40.

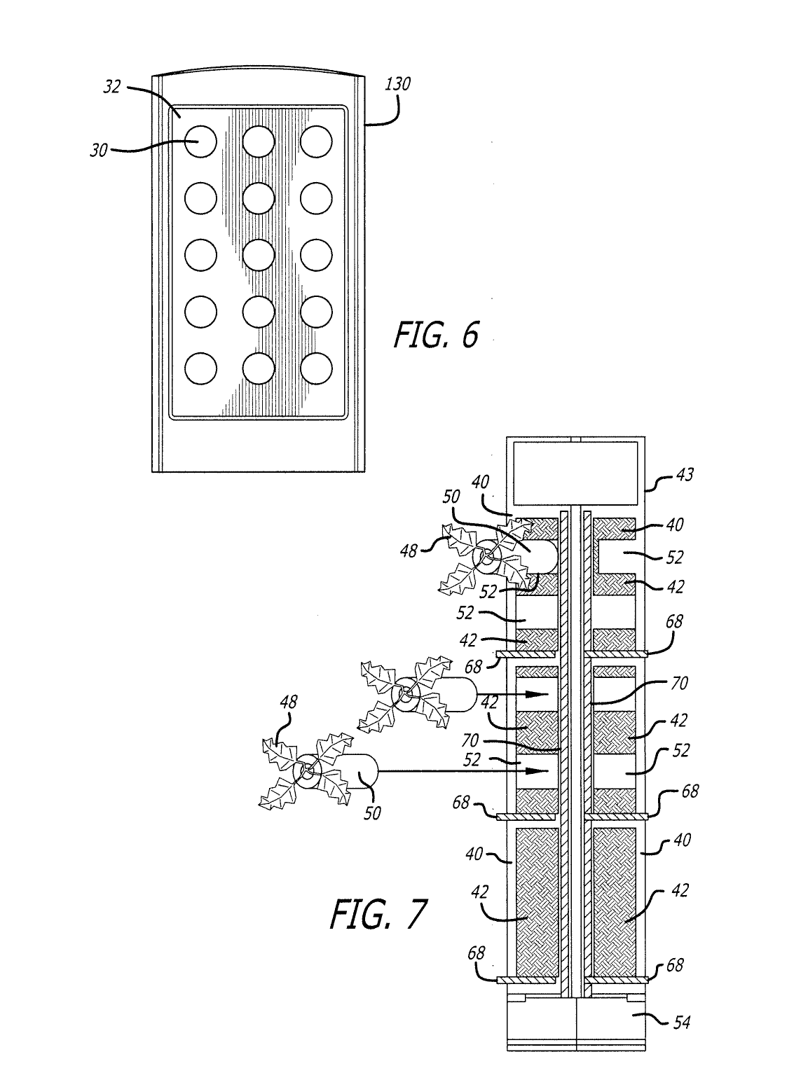

In another embodiment, for example shown in FIG. 6, the plant holder 130 need not include a pump for providing water and/or nutrients to the modules 40. In this embodiment, water and nutrients are manually supplied to the modules 40 without use of a pump mechanism. For example, water and/or nutrients may be poured into the tray 64 manually so as to supply water and/or nutrients via holes 66 to modules 40. In this embodiment, the plant holder 130 has a narrower dimension than the plant holder 10 having an internal pump mechanism.

As may be seen in FIGS. 7 and 14, the bottom of each module 40 includes a thin, horizontally disposed sheet 68. In one example, the sheet may take the form of a geotextile composite. Suitable geotextile composites are sold by Terram Limited, in Great Britain. These geotextile composite sheets 68 have a water impermeable, polymer-extruded mesh core (not shown). The sheet 68 has two sides both comprised of a permeable synthetic felt attached to the mesh core.

Water poured onto the top of the module 40 moves downwardly through that module 40. Much of the water in the module 40 is absorbed by the plants 48 retained within the module 40. Additional water, however, can make its way to the bottom of the module 40. At that bottom, the water reaches the geotextile composite sheets 68, which wicks the water from the module 40 to an adjacent module 40 located below.

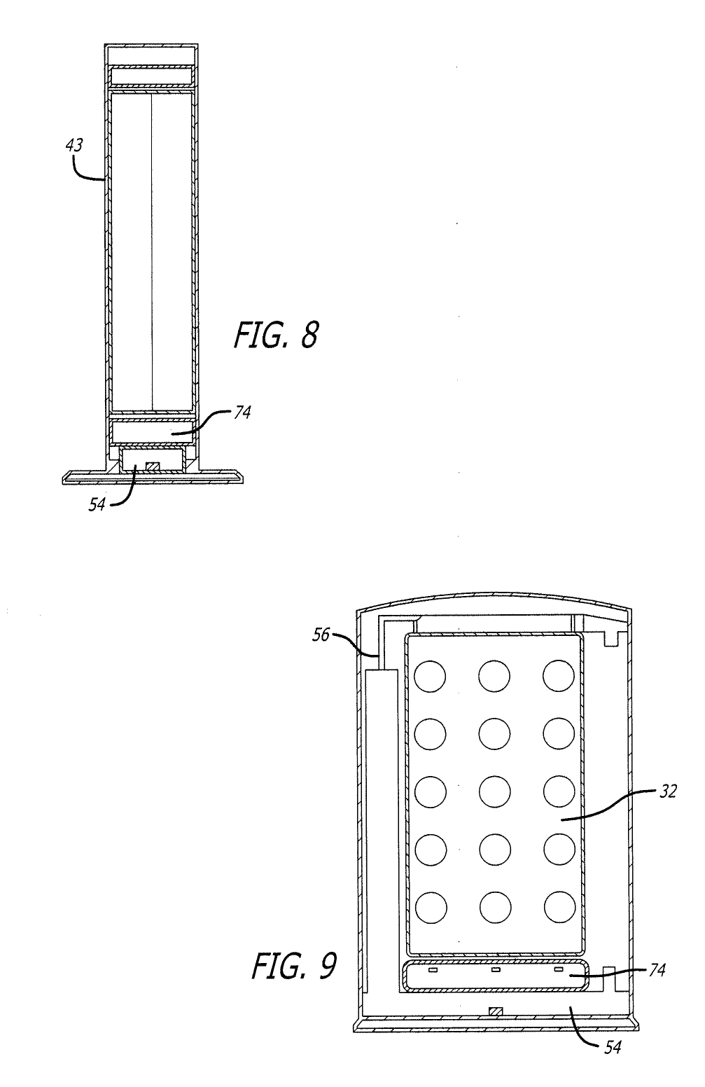

Once the modules 40 are saturated with water and/or nutrients, excess water travels through geotextile composite sheet 68 to a flat vertically disposed drainage mat 70. Two drainage mats 70 are shown in FIG. 7. FIG. 14 shows the first side 14 of the plant holder 10 having a drainage mat 70 disposed behind the modules 40 and composite sheets 68. Although not shown, it will be understood that in FIG. 14 a similar construction of modules 40, sheets 68 and a drainage mat 70 may be provided on second side 16 opposite to first side 14. Excess water is diverted from the geotextile composite sheets 68 to the drainage mat 70, and then downwardly to an overflow tank 74. Drainage mats 70 may include diagonally disposed channels (not shown) for diverting excess water downwardly to overflow tank 74. This overflow tank 74 is shown in FIGS. 8, 9, and 10. In this preferred embodiment, the tank 74 has a capacity of approximately six (6) ounces.

As indicated above, the rotating plant holder 10 also includes a lower base element 46 upon which the upper base element 44 rotates. In the event that the amount of water being diverted to the overflow tank 74 exceeds that tank's capacity, the excess water flows over the top of that tank 74. Any such escaping water falls onto and is collected in the underlying concave upper surface 78 (see FIGS. 1 and 3) of the upper base element 44.

As noted above, and as may best be seen in FIGS. 7-9 and 11, the plant holder 10 further includes an internal water reservoir 54. The water reservoir 54 may be filled with either water alone, or water and a dissolved, granular fertilizer, a liquid fertilizer, or some other form of nutrients. Water and the water/nutrient combination are used to provide supplemental moisture and nutrition to the plants of the plant holder 10. Particularly, a few ounces of water/nutrient mix may be pumped onto the top modules 40, every two to four days.

The reservoir may be filled via a fill tube 90 fluidly connected to the water reservoir 54, as shown in FIG. 16. The fill tube 90 may be fluidly connected to distributing tray 64 so that water and/or nutrients may be poured into tray 64 and flow through an opening 92 formed in the tray 64 and down through fill tube 90 and into reservoir 54. The tray 64 is accessible through a first pivoting door or case cover 80 (see FIG. 1), at the top of the plant holder 10. A second pivoting door 82 or case cover, opposite the first pivoting door 80, may also be seen in FIG. 1. This second pivoting door 82 permits access to the handle 58 and spout 62 of the manually activated pump 56.

As may be seen in FIG. 4, the fourth side 20 of the plant holder 10 may include a thin window 84 that extends from the top to the bottom of the plant holder 10. A float 86 placed within that window 84 provides a visual indication of the height of the water within the fill tube 90 or supply tube 60.

As may be seen in FIGS. 1 and 3, the plant holder includes a third door 88. This door 88 may be removed or otherwise opened to permit access to the interior of the plant holder 10. Once the door 88 is removed, larger “soaking” amounts of water or nutrients may be placed into the interior of the plant holder, to quickly saturate the modules 40. Such saturation wetting of the modules may typically be necessary once per month.

In order to prevent mold formation in the modules 40, each of the modules 40 may include vent holes (not shown). Five such vent holes, on each of the opposed sides of the modules 40, permit cross-ventilation.

As shown in FIGS. 14-16, plants 48 secured to plugs 50 may be inserted into orifices 30 of the plant holder 10. As discussed above, the plugs 50 are secured in the recesses 52 of the growth media 42. The plants may be arranged in any orientation or configuration and is user-defined. The plants 48 and plug 50 combination may be pre-grown and packaged, such that plants 48 may be exchanged with other plants 48, as discussed above. As shown in FIG. 17, the plants 48 secured to plugs 50, may be placed in a package 110 that is separate from the plant holder 10 so that the plants held by plant holder 10 may be replaced and exchanged with plants from the package 110.

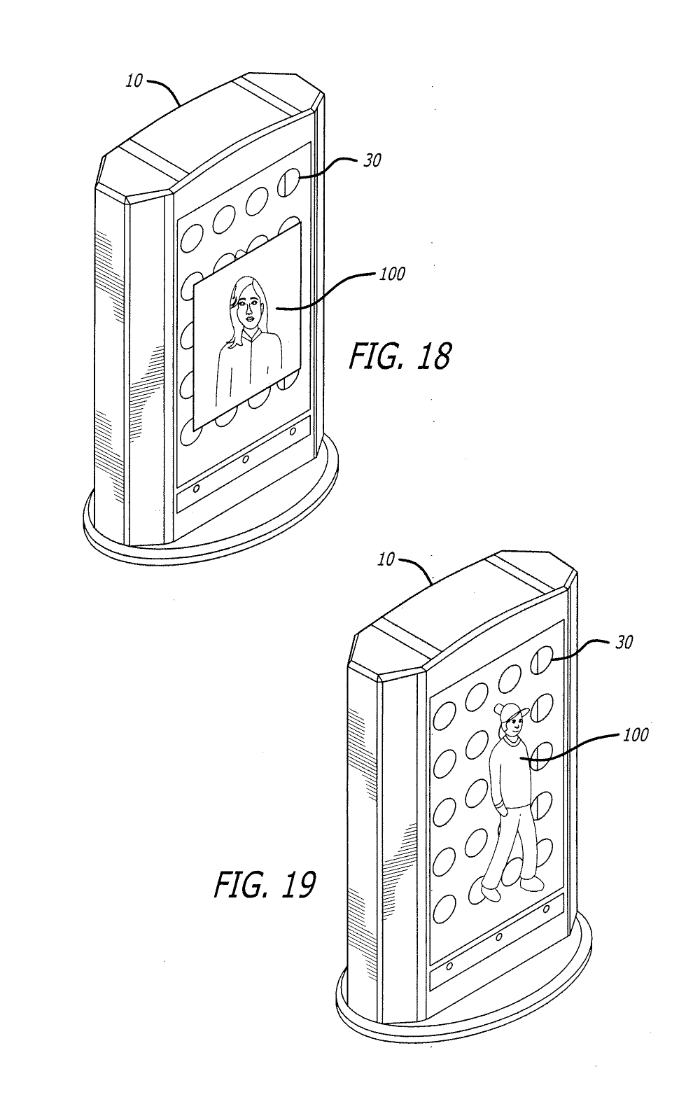

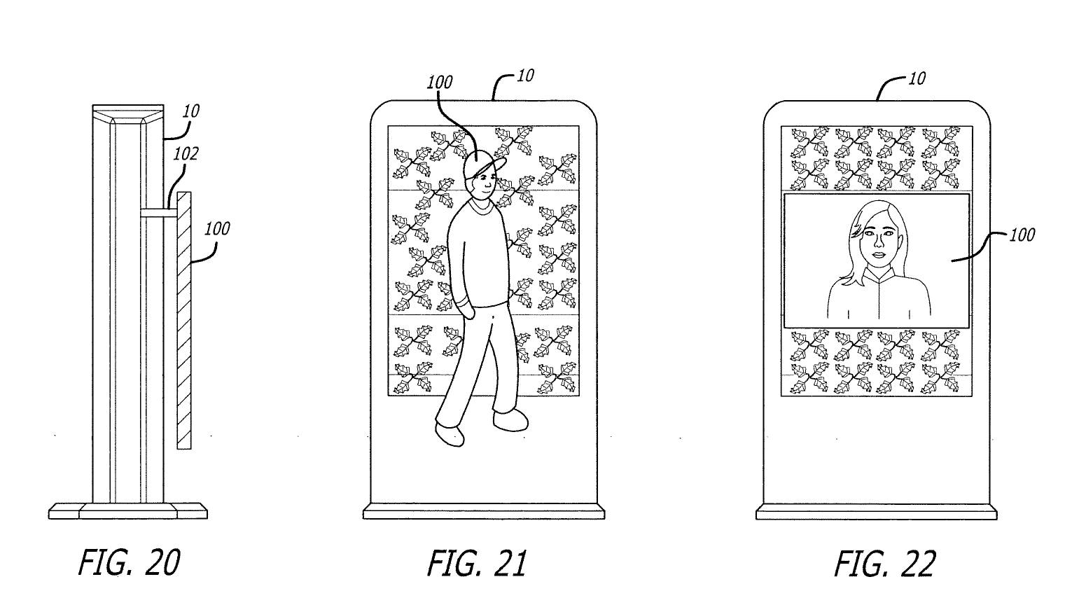

As shown in FIGS. 18-22, additional ornamentation may be secured to the plant holder 10. As shown, non-botanic media 100 may be secured via a hook 102 or other suitable securing mechanism to the plant holder 10. The non-botanic media 100 may take any form suitable for placement on the holder 10 and is not limited by the disclosure herein. The image may take the form of a picture, design, graphic, video, clock, logo, mirror or any other design or device suitable for placement on the plant holder. The non-botanic media 100 is preferably removably secured to the plant holder 10 so that they may be replaced or exchanged.

The advantages of the plant holder 10 are now apparent. The plant holder 10 is self-sufficient, in that no water supply lines need be connected to the unit. No energy, electricity, batteries, or power cords are necessary. Moreover, the plant holder 10 stands freely, and does not require external drainage. The plants can be easily replaced, either singly or in multiple units. The plant holder includes a broad base, and thus cannot be easily tipped on its side. The base is rotatable to allow for rotation of the plant holder towards sunlight or artificial light. The base also collects excess water supplied to the plant holder which prevents excess water from spilling from the plant holder and onto the table top or desk top.

The invention is:

1. A multi-sided, rotating plant holder, comprising: (a) a hollow shell structure; (b) orifices along at least one side of that shell structure for removing and replacing plants within that shell structure; (c) a growth medium contained within that shell structure; and (d) at least a lower base element, upon which the hollow shell structure rotates.

2. The rotating plant holder of claim 1, wherein said plant holder is of a generally rectangular shape.

3. The rotating plant holder of claim 1, wherein said plant holder is of a generally spherical shape.

4. The rotating plant holder of claim 1, wherein said plant holder is of a generally hemispherical shape.

5. The rotating plant holder of claim 1, wherein the plant holder houses a growth medium.

6. The rotating plant holder of claim 5, wherein said growth medium is formed into a plurality of modules.

7. The rotating plant holder of claim 6, wherein said modules are of a substantially rectangular, brick shape.

8. The rotating plant holder of claim 7, wherein orifices are placed on the outside of the rotating plant holder to permit the plants to have access to the growth medium.

9. The rotating plant holder of claim 7, wherein said modules are in a stacked and adjacent relationship relative to each other.

10. The rotating plant holder of claim 6, wherein each module includes a thin, horizontally disposed sheet positioned adjacent the bottom of each module

11. The rotating plant holder of claim 10, wherein excess water is diverted by said horizontally disposed sheets to a thin, flat vertically disposed drainage mat.

12. The rotating plant holder of claim 11, wherein said thin, flat vertically disposed drainage mat includes a plurality of diagonal channels for diverting excess water from the modules to an overflow tank.

13. The rotating plant holder of claim 1, further comprising an internal water reservoir, and a manually activated pump for moving water within the water reservoir from a position below the growth medium to a position above the growth medium, for sprinkling onto the growth medium.

14. The rotating plant holder of claim 1, wherein said orifices are placed upon panels.

15. The rotating plant holder of claim 1, wherein said panels abut against said modules to secure said modules within said shell structure.

16. The rotating plant holder of claim 14, wherein said panels are permanently secured to said shell structure.

17. The rotating plant holder of claim 1, further comprising an upper base element, the upper and lower base elements being rotatable relative to each other.

18. The rotating plant holder of claim 1, wherein plants are contained within a substantially cylindrical plug, and wherein said plants and substantially cylindrical plug are inserted and removed through the orifices, and into correspondingly shaped and sized holes in the growth medium.

19. A multi-sided, rotating plant holder, comprising: (a) a hollow shell structure; (b) orifices along at least one side of that shell structure for accessing plants within that shell structure; (c) a plurality of stacked, side-by-side modules, each of said modules comprised of a growth medium and being permanently secured within that shell structure; (d) a thin, water-permeable sheet positioned adjacent the bottom of said modules; (e) a water reservoir; (f) a manually-actuated pump for moving water from the water reservoir into a position above the modules; (g) an upper base element, with a concave upper surface, for receiving overflow water; and (h) a lower base element upon which the upper base element rotates.

20. The multi-sided, rotating plant holder of claim 14, further comprising a thin, vertically disposed drainage mat including diagonally disposed channels, the channels for collecting excess water from the growth medium, and diverting the excess water into an overflow tank.
